(19) United States
(12) Patent Application Publication
(10) Pub. No.: US 2011/0156484 A1
(43) Pub. Date: Jun. 30, 2011

(54) Reliable photovoltaic power system employing smart virtual low voltage photovoltaic modules

(75) Inventors: Huo-Hsien Chiang, Taipei City (TW); Chiou Fu Wang, Yonghe City (TW)

(73) Assignee: Du Pont Apollo Ltd.

(21) Appl. No.: 12/926,623

(22) Filed: Nov. 30, 2010

Related U.S. Application Data
(60) Provisional application No. 61/291,225, filed on Dec. 30, 2009.

(51) Int. Cl. H02J 1/10

(52) U.S. Cl. 307/71

(57) ABSTRACT

A reliable photovoltaic (PV) power system is provided, including a plurality of smart virtual low voltage PV modules arranged in a plurality of columns and a plurality of rows. The smart virtual low voltage PV modules on the same column are connected in series. The smart virtual low voltage PV modules on the same row are connected in parallel. Each of the smart virtual low voltage PV modules comprises: one or more photovoltaic cells, configured to convert solar energy into DC power. The system further includes a DC/DC converting unit, coupled to the PV module, configured to communicate with a control center to acquire from the control center a determined level value, thereby converting the DC power received from the PV module into a demanded output voltage having the determined level value.

### FIELD OF THE INVENTION

The invention relates generally to a photovoltaic (PV) power system, more particularly, to a reliable photovoltaic power system employing smart virtual low voltage photovoltaic modules.

### BACKGROUND OF THE INVENTION

Recently, the photovoltaic industry has been growing to meet an increasing need for electricity. The continuous challenge in the photovoltaic industry is to develop and manufacture photovoltaic power systems having a high efficiency for converting solar energy into electrical energy. The more efficient the photovoltaic system is at performing such a conversion, the greater amount of electricity can be generated for a given investment.

Additionally, a photovoltaic power system utilizing photovoltaic modules having low output voltages is more favorable, because such low-voltage PV modules can provide many advantages including lower wiring costs and easier string design. However, conventional thin film amorphous silicon PV modules often have high output voltages (greater than 20V) and therefore cannot meet the requirements for low manufacturing costs and easier design.

Additionally, since PV power systems are generally mounted outdoors, they need to have high environment resistance reliability. However, conventional PV systems available suffer poor reliability owing to operation failures of the conventional modules caused by various uncertainties.

### SUMMARY OF THE INVENTION

In view of above, a reliable PV power system utilizing smart virtual low voltage photovoltaic modules is provided, which can provide advantages such as reduced wire costs and easier design due to the employment of the smart virtual low voltage photovoltaic modules. Additionally, the reliable PV power system can circumvent mismatch problems and can thus have high conversion efficiency. Additionally, the reliable PV power system can provide improved reliability and thus can operate against component failure scenarios caused by various uncertainties.

In accordance with an embodiment, a reliable photovoltaic (PV) power system comprises a plurality of smart virtual low voltage PV modules arranged in a plurality of columns and a plurality of rows, wherein the smart virtual low voltage PV modules on the same column are connected in series, and the smart virtual low voltage PV modules on the same row are connected in parallel. Additionally, each of the smart virtual low voltage PV modules comprises one or more photovoltaic cells, configured to convert solar energy into DC power; and a DC/DC converting unit, coupled to the PV module, configured to communicate with a control center to acquire from the control center a determined level value, thereby converting the DC power received from the PV module into a demanded output voltage having the determined level value.

These and other features, aspects, and embodiments are described below in the section entitled “Detailed Description of the Invention.”

### BRIEF DESCRIPTION OF THE DRAWINGS

Features, aspects, and embodiments are described in conjunction with the attached drawings, in which:

FIG. 1 is a schematic diagram illustrating the architecture of a photovoltaic (PV) power system in accordance with an embodiment of the present invention;

FIG. 2 is a flowchart illustrating a procedure to determine the level values of respective demanded output voltages for normally-operating smart virtual low voltage PV modules in the PV power system of FIG. 1 in accordance with an embodiment of the present invention;

FIG. 3 is a schematic diagram illustrating the architecture of a reliable photovoltaic (PV) power system having improved reliability in accordance with an embodiment of the present invention;

FIG. 4 is a flowchart illustrating a procedure to determine the level values of respective demanded output voltages for normally-operating smart virtual low voltage PV modules of FIG. 3 in accordance with an embodiment of the present invention; and

FIG. 5 is a schematic diagram illustrating the architecture of a smart virtual low voltage PV module applicable to the PV power system of FIG. 1 or FIG. 3 in accordance with an embodiment of the present invention.

### DETAILED DESCRIPTION OF THE INVENTION

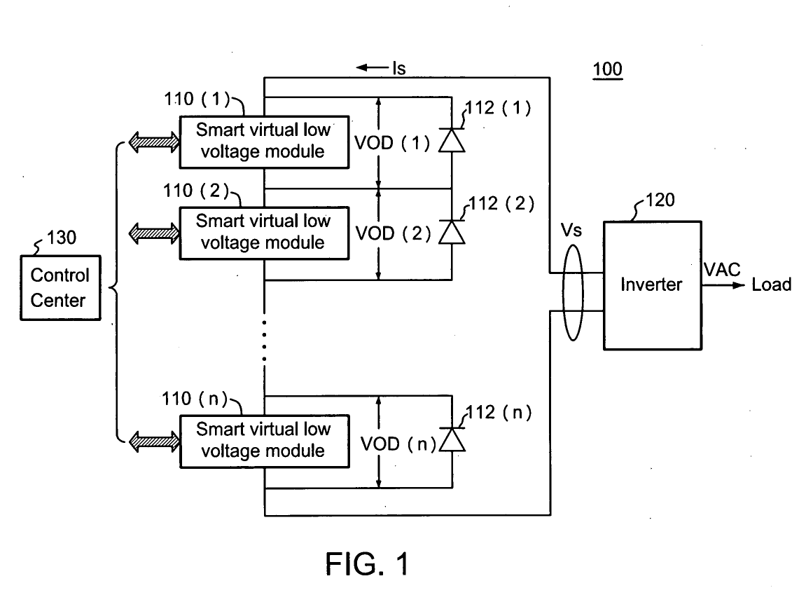

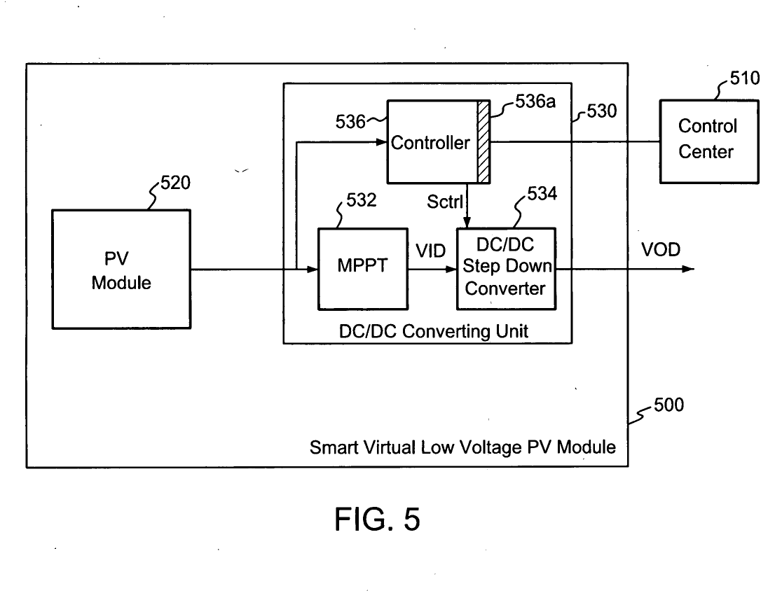

FIG. 1 is a schematic diagram illustrating the architecture of a photovoltaic (PV) power system 100 in accordance with an embodiment. As shown, the PV power system 100 comprises a plurality of smart virtual low voltage PV modules 110(1)-110(n) (wherein n is an integer greater than 1) connected in series as a string. Additionally, each of the smart virtual low voltage PV modules 110(1)-110(n) can be wiredly or wirelessly coupled to a control center 130. The smart virtual low voltage PV modules 110(i) (wherein 1≦i≦n) are configured to communicate with the control center 130 and thereby convert solar energy into a demanded output voltage VOD(i) having a level value determined by the control center 130. Detailed architecture and operation of each of the smart virtual low voltage PV modules 110(1)-110(n) are described with reference to the descriptions in connection with an embodiment illustrated in FIG. 5.

Additionally, the PV power system 100 can comprise a plurality of bypass diodes 112(1)-112(n), each connected in parallel with a corresponding one of the smart virtual low voltage PV modules 110(1)-110(n). With the parallel connection, the bypass diode 112(i) can provide a bypass path to the corresponding PV modules 110(i) if the corresponding PV modules 110(i) fails to operate normally.

Additionally, the PV power system 100 can further include an inverter 120 coupled between the string of the smart virtual low voltage PV modules 110(1)-110(n) and a load such as a power grid (not shown). The inverter 120 is configured to convert a system output voltage Vs provided by the string of the smart virtual low voltage PV modules 110(1)-110(n) into an AC (alternating current) voltage VAC for output to the load.

Additionally, the PV power system 100 can include or can be coupled externally to the control center 130, which can communicate with and thereby control each of the smart virtual low voltage PV modules 110(1)-110(n). Preferably, the control center 130 can perform the determination based on a condition that each normally-operating smart virtual low voltage PV module operates with an instantaneous maximum power production (i.e., at a respective instantaneous maximum power point). More preferably, the control center 130 can perform the determination based on another condition that the system output voltage Vs provided by the normally-operating ones in the smart virtual low voltage PV modules 110(1)-110(n) is equal to a predetermined voltage, e.g., an optimal input voltage of the inverter 120.

Benefiting by the implementation of the bypass diodes 120(1)-120(n) that can provide bypass paths for the corresponding smart virtual low voltage PV modules 110(1)-110(n), respectively, even if any one or more of the smart virtual low voltage PV modules 110(1)-110(n) fail to operate normally, no open circuit (or break circuit) will occur to result in an entire operation failure of the string of the smart virtual low voltage PV modules 110(1)-110(n).

Accordingly, no matter whether all of the smart virtual low voltage PV modules 110(1)-110(n) are normally operating or not, the control center 130 can still communicate with the ones among the smart virtual low voltage PV modules 110(1)-110(n) that are still normally-operating, and determine the level value of the respective demanded output voltage for each normally-operating smart virtual low voltage PV module. Consequently, the PV power system 100 can operate against component failure scenarios caused by various uncertainties.

It is noted that although the bypass diode 112(i) in the embodiment is connected externally to the smart virtual low voltage PV module(i), it is only for purpose of illustration without limiting the protection scope of the present invention. For example, in an alternative embodiment, the bypass diode 112(i) can be integrated with the smart virtual low voltage PV module(i).

Additionally, it should be noted that although in the embodiment of FIG. 1, a single diode is used to provide a bypass path for each of the smart virtual low voltage PV module 110(1)-110(n), but the present invention is not limited thereto. For example, in other embodiments, any electric component capable of providing a bypass path can also be utilized, such as a plurality of diodes, one or more transistors, one or more resistors, any other resistor-like components, or a combination thereof.

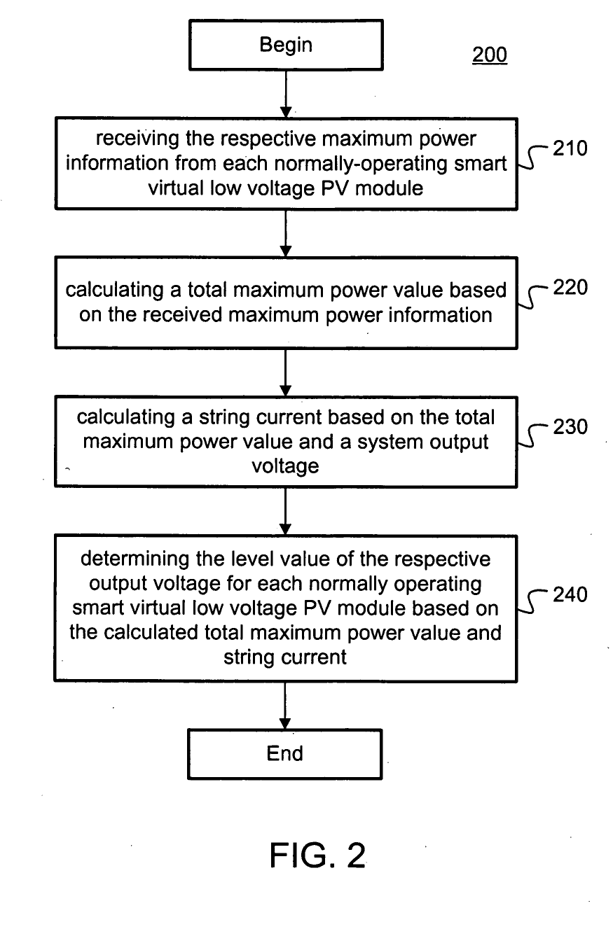

FIG. 2 is a flowchart illustrating a method 200 performed by the control center 130 of FIG. 1 to determine the level values of the respective demanded output voltages for the normally-operating smart virtual low voltage PV modules in the PV power system of FIG. 1 in accordance with an embodiment. The method 200 can be performed regardless of whether all of the smart virtual low voltage PV modules 110(1)-110(n) are normally operating or not.

In the embodiment, the control center 130 performs the determination such that each normally-operating smart virtual low voltage PV module operates with an instantaneous maximum power production, and the smart virtual low voltage PV modules that are still operating normally can provide a system output voltage Vs equal to a predetermined voltage (e.g., an optimal input voltage of the inverter 120).

As shown in FIG. 2, the method 200 is started at step 210, where the control center 130 can receive the respective maximum power information from each normally-operating smart virtual low voltage PV module 110(j), wherein j is an integer representative of the index of each normally-operating smart virtual low voltage PV module.

Next, in step 220, the control center 130 can calculate a total maximum power value “Ps” by summing the respective maximum power value “Pmp(j)” of each normally-operating smart virtual low voltage PV module 110(j). As an example, the total maximum power value Ps is equal to Pmp(1)+Pmp(2) if only the smart virtual low voltage PV modules 110(1) and 110(2) are still normally operating.

Next, the method 200 enters step 230, where the control center 130 can calculate a string current “Is” as: Is =PsNs, where Vs is the system output voltage equal to a predetermined voltage (e.g., an optimal input voltage for the inverter 120) as described above.

Next, in step 240, the control center 130 can determine the level value of the respective output voltage VOD(j) for each normally-operating smart virtual low voltage PV module 110(j) as: VOD(j)=Pmp(j)/Is.

As a result, regardless of whether all of the smart virtual low voltage PV modules 110(1)-110(n) are normally operating or not, and whether the smart virtual low voltage PV modules 110(1)-110(n) are matched to each other or not, not only can each normally-operating smart virtual low voltage PV modules operate at respective maximum power point to provide maximum power production, but also all normally-operating smart virtual low voltage PV modules can collectively provide the system output voltage Vs optimal for input to the inverter 120. In other words, the reliable PV power system 100 can provide reliability against component failures, while circumventing mismatch problems between PV modules and providing high conversion efficiency.

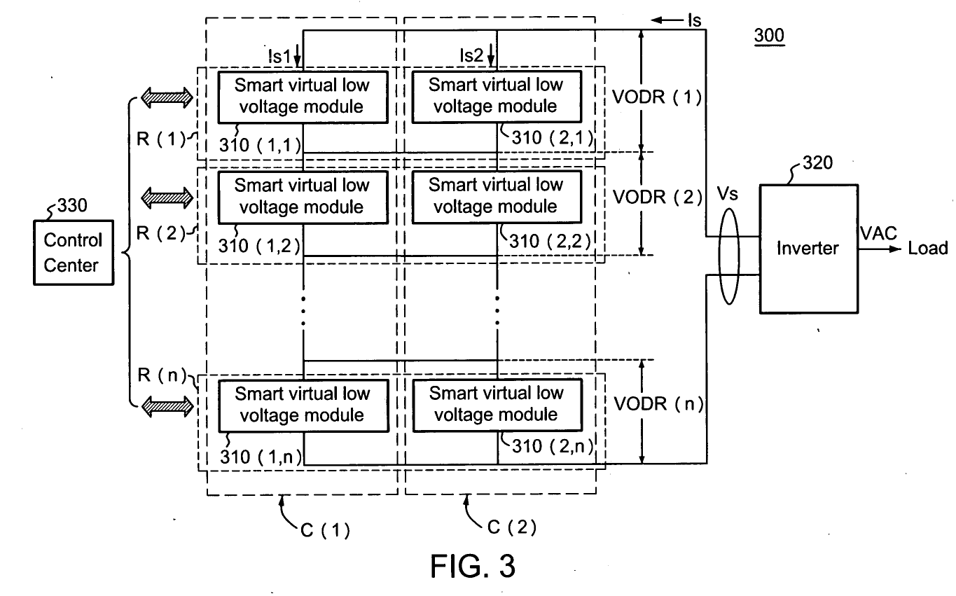

FIG. 3 is a schematic diagram illustrating the architecture of a reliable photovoltaic (PV) power system 300 in accordance with an embodiment of the present invention. The PV power system 300 can have improved reliability compared to the PV power system 100 of FIG. 1

The PV power system 300 differs from the PV power system 100 of FIG. 1 mainly in that the plurality of smart virtual low voltage PV modules 110(1)-110(n) and the bypass diodes 112(1)-112(n) in the PV power system 100 are replaced with a plurality of smart virtual low voltage PV modules 310(i,1)-310(m,n), wherein m and n are both integers and m is taken as 2 in the embodiment for purpose of illustration without limiting the protection scope of the present invention.

As shown, the smart virtual low voltage PV modules 310(i,1)-310(m,n) can be arranged in a plurality of columns C(1)-C(m) and a plurality of rows R(1)-R(n). The smart virtual low voltage PV modules 310(i,1)-310(i,n) on the same column C(i) (where 1≦i≦m) are connected in series as a string. Additionally, the smart virtual low voltage PV modules 310(1,j)-310(m,j) on the same row R(i) (where 1≦j≦n) are connected in parallel.

Similar to that in FIG. 1, each of the smart virtual low voltage PV modules 310(i,j) (wherein 1≦i≦m and 1≦j≦n) is wiredly or wirelessly coupled to a control center 330. The smart virtual low voltage PV module 310(i,j) can communicate with the control center 330 and thereby convert solar energy into a demanded output voltage VOD(i,j) (not shown) having a level value determined by the control center 330.

Because the smart virtual low voltage PV modules 310(1,j)-310(m,j) on the same row R(j) are connected in parallel, the output demanded output voltages VOD(1,j)-VOD(m,j) can be equal to the same level (hereafter denoted as “VODR(j)”). Namely, VODR(j)=VOD(1,j)=VOD(2,j)= . . . =VOD(m,j). Detailed architecture and operation of each of the smart virtual low voltage PV modules 310(1,1)-310(m,n) are described with reference to the descriptions in connection with an embodiment illustrated with FIG. 5.

With such a connection configuration, the smart virtual low voltage PV modules 310(1,j)-310(m,j) on the same row R(j) can provide bypass paths mutually to each other if any one or more of them fail to operate normally. This means that each of the smart virtual low voltage PV modules 310(1,j)-310(m,j) on the row R(j) can have (m=1) bypass paths provided by the other smart virtual low voltage PV modules on the same row.

Accordingly, the PV power system 300 can operate against component failure scenarios caused by various uncertainties. Only when all of the P(1,j)-P(m,j) on the same row R(j) fail to operate normally will an open circuit (or break circuit) occur in the row R(j) to result in an entire operation failure of the smart virtual low voltage PV modules 310(1,1)-310(m,n). With the increase of the total number “m” of the columns, the system reliability can be increased.

Consequently, compared with the PV power system 100 of FIG. 1 where each smart virtual low voltage PV module has a corresponding bypass diode acting as a bypass path, the PV power system 300 of FIG. 3 can have higher reliability. Additionally, with the exclusion of the bypass diodes 112(1)-112(n) of FIG. 1 that often require high manufacturing costs, the PV power system 300 can have lower manufacturing costs.

Additionally, the PV power system 300 can further include an inverter 320 coupled between the smart virtual low voltage PV modules 310(1,1)-310(m,n) and a load such as a power grid (not shown). The inverter 320 is configured to convert a system output voltage Vs provided by the smart virtual low voltage PV modules 310(1,1)-310(m,n) into an AC voltage VAC for output to the load.

Additionally, the PV power system 300 can include or can be coupled externally to the control center 330, which can communicate with and thereby control each of the smart virtual low voltage PV modules 310(1,1)-310(m,n).

Preferably, the control center 330 can perform the determination based on a condition that each normally-operating smart virtual low voltage PV module operates with an instantaneous maximum power production (i.e., at a respective maximum power point). More preferably, the control center 330 can perform the determination based on another condition that the system output voltage Vs provided by the smart virtual low voltage PV modules 310(1,1)-310(m,n) is equal to a predetermined voltage, e.g., an optimal input voltage of the inverter 320.

Similarly, no matter whether all of the smart virtual low voltage PV modules 310(1,1)-310(m,n) are normally operating or not, the control center 330 can still communicate with the ones among the smart virtual low voltage PV modules 310(1,1)-310(m,n) that are still normally-operating, and determine the level value of the respective demanded output voltage for each normally-operating smart virtual low voltage PV module.

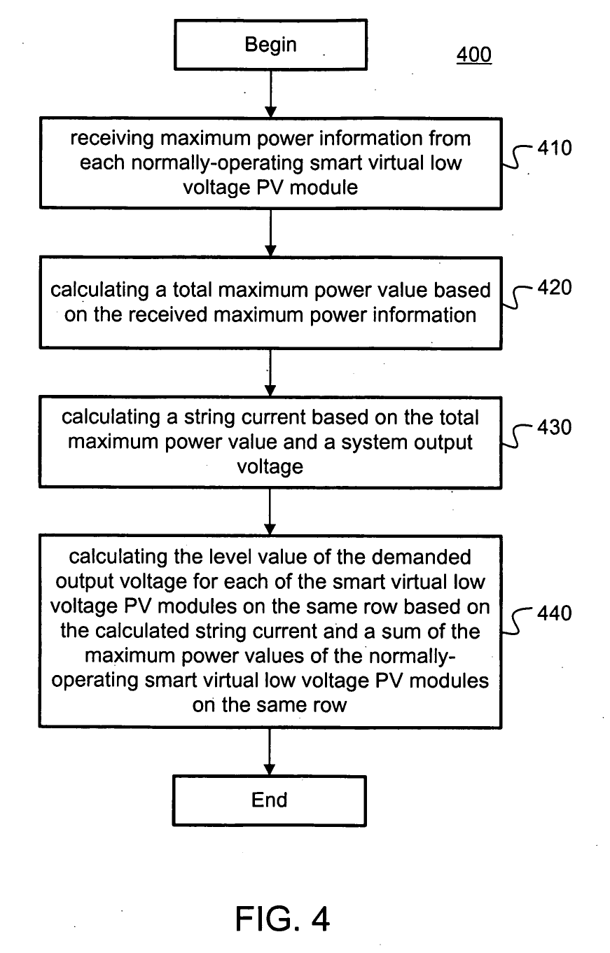

FIG. 4 is a flowchart illustrating a method 400 performed by the control center 330 of FIG. 3 to determine the level value of the respective demanded output voltage for the normally-operating smart virtual low voltage PV modules in accordance with an embodiment of the present invention. The method 400 can be performed regardless of whether all of the smart virtual low voltage PV modules 310(1,1)-310(m,n) are normally operating or not.

As shown, the method 400 is started at step 410 which is similar to step 210 of FIG. 2, where the control center 330 can receive the respective maximum power information from each normally-operating smart virtual low voltage PV module 310(i,j), wherein i and j are both integers representative of each normally-operating smart virtual low voltage PV module.

Next, in step 420 which is similar to step 220 of FIG. 2, the control center 330 can calculate a total maximum power value “Ps” by summing the respective maximum power value “Pmp(j)” of each normally-operating smart virtual low voltage PV module 310(i,j). As an example, the total maximum power value Ps is equal to Pmp(1,1)+Pmp(2,2) in a case where only the smart virtual low voltage PV modules 310(1,1) and 310(2,2) are still normally operating.

Next, the method 400 enters step 430 which is similar to step 230 of FIG. 2, where the control center 330 calculates a string current “Is” as: Is=PsNs, where Vs is the system output voltage as described above.

Next, in step 440, the control center 330 can determine the level value of the respective output voltage VODR(j) for each row R(j) as: VODR(j)=PRmp(j)/Is, where PRmp(j) denotes a sum of the maximum power values of the normally-operating smart virtual low voltage PV modules on the same row R(j). For example, in the case where only the smart virtual low voltage PV modules 310(1,1) and 310(2,2) are still normally operating, PRmp(1)=Pmp(1,1), and PRmp(2)=Pmp(2,2). Accordingly, the level value of the respective demanded output voltage of each normally-operating smart virtual low voltage PV module on the row R(j) can be determined to be equal to the determined level value of VODR(j) as described in connection with FIG. 3. Step 430 differs in step 230 only in that the level values for all of the normally-operating smart virtual low voltage PV modules on the same row R(j) can be determined.

As a result, regardless of whether all of the smart virtual low voltage PV modules 310(1,1)-310(m,n) are normally operating or not, and whether the smart virtual low voltage PV modules 310(1,1)-310(m,n) are matched to each other or not, not only can each normally-operating smart virtual low voltage PV modules operate at respective maximum power point, all normally-operating smart virtual low voltage PV modules can collectively provide the system output voltage Vs optimal for input to the inverter 320. In other words, the reliable PV power system 300 can provide reliability against component failures, while circumventing mismatch problems between PV modules and thus providing high conversion efficiency.

FIG. 5 is a schematic diagram illustrating the architecture of a smart virtual low voltage PV module 500 in accordance with an embodiment. The smart virtual low voltage PV module 500 can be applicable to the PV power system 100 of FIG. 1 or the reliable PV power system 300 of FIG. 3 to serve as each of the smart virtual low voltage PV module 110(1)-110(n) and 310(1)-310(m,n).

As shown, the smart virtual low voltage PV module 500 can comprise a PV module 520 and a DC/DC converting unit 530. The PV module 520 is configured to convert solar energy into DC power for output to the DC/DC converting unit 530. The DC/DC converting unit 530, coupled to the PV module 520, is configured to communicate with a control center 540 to acquire a level value determined by the control center 540, thereby converting the DC power output from the PV module 520 into a demanded output voltage VOD having the level value.

FIG. 5 also illustrates a detailed embodiment of the DC/DC converting unit 530. As shown, the DC/DC converting unit 530 can include a maximum power point tracker (MPPT) 532, a DC/DC step down converter 534, and a controller 536.

The MPPT 532, coupled to the PV module 520, is configured to track a maximum power operation point for the DC power output by the PV module 520, thereby maximizing the DC power transferred from the PV module 520. The DC/DC step down converter 534, coupled between the MPPT 532 and the controller 536, is configured to convert a DC input voltage VID generated from the MPPT 532 into the demanded output voltage VOD in accordance with a control of the controller 536. The controller 536, coupled between the DC/DC step down converter 534 and the control center 540, is configured to determine a voltage conversion ratio for the DC/DC step down converter 534 in accordance with the control of the control center 540. The controller 536 can preferably have a wireless communication interface 536a having wireless communication capability with the control center 540. With such a configuration, the DC/DC converting unit 530 can convert the DC input voltage VID into the demanded output voltage VOD having a level value determined by the control center 540.

Because the level of the demanded output voltage VOD in the smart virtual low voltage PV module 500 can be lower than that in conventional technologies employing a typical PV module to directly output an output voltage to an inverter without any conversion, the PV power systems 100 and 300 employing such smart virtual lower voltage PV modules can have reduced wiring costs and have achieved an easier design. More details of the architecture and operation of a smart virtual low voltage PV module applicable to the PV power system of FIG. 1 or FIG. 3 are described in U.S. Patent Application No. 61/264,010 filed by the same applicant and incorporated herein by reference.

While certain embodiments have been described above, it will be understood that the embodiments described are by way of example only. Accordingly, the device and methods described herein should not be limited to the described embodiments. Rather, the device and methods described herein should only be limited in light of the claims that follow when taken in conjunction with the above description and accompanying drawings.

What is claimed is:

1. A reliable photovoltaic (PV) power system, comprising:
a plurality of smart virtual low voltage PV modules arranged in a plurality of columns and a plurality of rows, wherein the smart virtual low voltage PV modules on the same column are connected in series, the smart virtual low voltage PV modules on the same row are connected in parallel, and each of the smart virtual low voltage PV modules comprises:
one or more photovoltaic cells, configured to convert solar energy into DC power; and
a DC/DC converting unit, coupled to the PV module, configured to communicate with a control center to acquire from the control center a determined level value, thereby converting the DC power received from the PV module into a demanded output voltage having the determined level value.

2. The reliable PV power system of claim 1, further comprising an inverter coupled to the smart virtual low voltage PV modules, configured to convert a system output voltage received from the smart virtual low voltage PV modules into an AC voltage.

3. The reliable PV power system of claim 1, wherein each of the smart virtual low voltage PV modules is configured to provide the control center with its own instantaneous maximum power information.

4. The reliable PV power system of claim 1, wherein no matter whether all of the smart virtual low voltage PV modules are normally operating or not, the control center determines the level value of the respective demanded output voltage for each of the smart virtual low voltage PV modules that are normally-operating.

5. The reliable PV power system of claim 4, wherein the control center performs the determination based on a condition that each normally-operating smart virtual low voltage PV module operates with an instantaneous maximum power production.

6. The reliable PV power system of claim 4, wherein the control center performs the determination based on a condition that a system output voltage provided by the smart virtual low voltage PV modules is equal to an optimal input voltage of an inverter.

7. The reliable PV power system of claim 4, wherein the control center performs the determination by executing the following steps:
(i) calculating a total maximum power value of the smart virtual low voltage PV modules based on the respective maximum power values of the smart virtual low voltage PV modules that are normally operating,
(ii) calculating a string current of the smart virtual low voltage PV modules based on a system output voltage and the calculated total maximum power value, and
(iii) calculating the level value of the demanded output voltage for each of the smart virtual low voltage PV modules on each row based on the calculated string current and the respective maximum power values of the smart virtual low voltage PV modules that are normally operating.

8. The reliable PV power system of claim 7, wherein the control center performs the calculation of step (iii) comprises:
calculating the level value of the demanded output voltage for each of the smart virtual low voltage PV modules on the same row based on the calculated string current and a sum of the maximum power values of the normally-operating smart virtual low voltage PV modules on the same row.

9. The reliable PV power system of claim 1, wherein the respective DC/DC converting unit in each of the smart virtual low voltage PV modules comprises:
a maximum power point tracker, configured to track a maximum power operation point for the DC power received from the PV module;
a DC/DC step down converter, configured to convert a DC input voltage generated from the maximum power point tracker into the demanded output voltage; and
a controller, coupled between the DC/DC step down converter, configured to communicate with the control center to determine a voltage conversion ratio for the DC/DC step down converter in accordance with the control of the control center.
